(19) United States
(12) Patent Application Publication
(10) Pub. No.: US 2001/0047810 A1
(43) Pub. Date: Dec. 6, 2001

(54) HIGH RPM MEGASONIC CLEANING

(76) Inventors: JEFF FARBER, DELMAR, NY (US); ALLAN M. RADMAN, APTOS, CA (US); JULIA SVIRCHEVSKI, SAN JOSE, CA (US); HELMUTH TREICHEL, MILPITAS, CA (US)

Correspondence Address: MARTINE & PENILLA, LLP, 710 LAKEWAY DRIVE, SUITE 170, SUNNYVALE, CA, 94085, US

(21) Appl. No.: 09/343,208

(22) Filed: Jun. 29, 1999

(51) Int. Cl. B08B 3/12; B08B 7/04

(52) U.S. Cl. 134/1.3; 134/1; 134/34; 134/153; 134/902

(57) ABSTRACT

A method that involves spraying a liquid agitated with a sonic wave at a megasonic frequency onto a substrate from a nozzle positioned over the substrate. Simultaneously, the substrate is spun above 300 RPM while the nozzle is swept over the substrate. The substrate may be brushed in a brush station before agitating the liquid with the sonic wave. An apparatus having an arm in fluid communication with a nozzle that has an angular position θ greater than 0°. Also, there is a substrate spinner positioned below the nozzle.

### FIELD OF INVENTION

The field of invention relates to substrate cleaning in general and, more specifically, megasonic cleaning for semiconductor wafers.

### BACKGROUND OF THE INVENTION

In the manufacture of semiconductor devices, the surface of semiconductor wafers must be cleaned of wafer contaminants. If not removed, wafer contaminants may affect device performance characteristics and may cause device failure to occur at faster rates than usual. In general, there are two types of wafer contamination: particulates and metals. Particulates are tiny bits of material present on a wafer surface that have readily definable boundaries, for example, silicon dust, silica (SiO₂), slurry residue, polymeric residue, metal flakes, atmospheric dust, plastic particles, and silicate particles.

One method for removal of particulate contamination is megasonic rinsing. Megasonic rinsing involves cavitation. Cavitation is the rapid forming and collapsing of microscopic bubbles in a liquid medium under the action of sonic agitation. Sonic agitation involves subjecting the liquid to shock waves and, for megasonic rinsing, these shock waves occur at frequencies between 0.4 and 1.5 Mhz inclusive. In megasonic rinsing, a cavitated liquid is sprayed upon a spinning wafer surface.

When a cavitated liquid is sprayed on a spinning wafer, a boundary layer (i.e., a thin layer of liquid) forms over the wafer surface. As the wafer rotates, the boundary layer liquid generally has an outwardly radial flow across the wafer surface due to the centripetal force associated with the rotational motion of the wafer. Generally, the faster the wafer rotates, the thinner the boundary layer becomes since the liquid is more aggressively driven to the outer edge of the wafer by the centripetal force associated with the spinning wafer. The boundary layer liquid flows across the wafer surface and ultimately flies off the wafer once it reaches the wafer edge. The continuous spraying of megasonic liquid keeps the boundary layer thickness stable since the liquid that is spun off is simultaneously replaced by freshly sprayed liquid.

The cavitation activity occurring within the boundary layer liquid on the wafer surface displaces and loosens particulate contaminants associated with the wafer surface. The bubbles “pop-up” and cause the contaminants to loosen. Since the boundary layer liquid is also flowing across the wafer surface towards its edge, the loosened particles are carried by the fluid flow over the wafer surface and ultimately flown off with the liquid at the wafer edge. The centripital force associated with the rotating wafer also contributes to the outward motion of the particles, individually, besides the resulting fluid flow. In this manner megasonic rinsing assists in the cleaning of wafers.

Megasonic rinsing may be performed in any equipment outfitted with megasonic spray equipment and a wafer spinner. One example includes a wafer scrubber system 100 as shown in FIG. 1. In the system 100 shown in FIG. 1, wafers requiring cleaning are loaded in the indexer station 110 and scrubbed (or brushed) with brushes in the inside and outside brushing stations 120 and 130 respectively. Next the wafers are rinsed, spun and dried in station 140. The rinse, spin and dry station 140 is a location where megasonic rinsing as described above may take place. That is, the rinser of stage 140 is equipped with megasonic spray equipment.

A problem with megasonic spray technology is its relative immaturity. Thus, the effects of various megasonic spraying process parameters on cleaning efficiency (i.e., the number or percentage of particles removed from the wafer surface by the megasonic spraying process) is not well understood.

### SUMMARY OF THE INVENTION

A method is described that involves spraying a liquid agitated with a sonic wave at a megasonic frequency onto a substrate from a nozzle positioned over the substrate. Simultaneously, the substrate is spun above 300 RPM while the nozzle is swept over the substrate. The substrate may be brushed in a brush station before agitating the liquid with the sonic wave.

An apparatus is also described having an arm in fluid communication with a nozzle that has an angular position θ greater than 0°. Also, there is a substrate spinner positioned below the nozzle.

### BRIEF DESCRIPTION OF THE DRAWINGS

The present invention is illustrated by way of example and not limitation in the figures of the accompanying drawings, in which like references indicate similar elements, and in which:

FIG. 1 shows an example of a brush scrubbing system.

FIGS. 2a,b,c show an example of a megasonic spray apparatus.

FIG. 3 shows an example of a nozzle having non-zero angular position.

### DETAILED DESCRIPTION

A method is described that involves spraying a liquid agitated with a sonic wave at a megasonic frequency onto a substrate from a nozzle positioned over the substrate. Simultaneously, the substrate is spun above 300 RPM while the nozzle is swept over the substrate. The substrate may be brushed in a brush station before agitating the liquid with the sonic wave.

An apparatus is also described having an arm in fluid communication with a nozzle that has an angular position θ greater than 0°. Also, there is a substrate spinner positioned below the nozzle.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured only in terms of the claims.

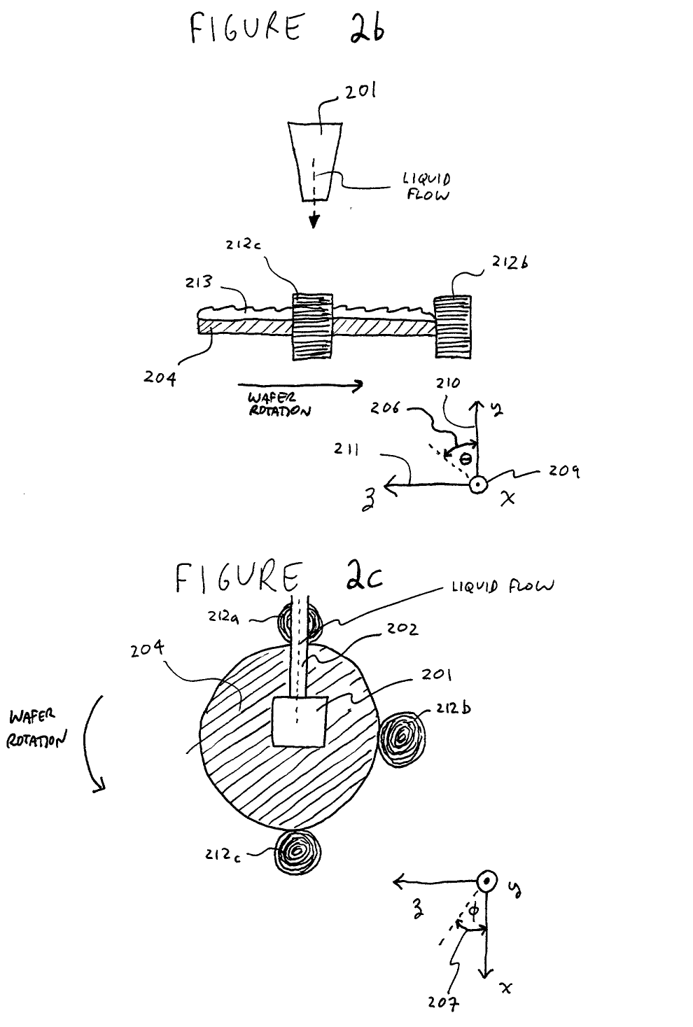

An example of the aforementioned megasonic spray equipment 200 is shown in FIG. 2. The megasonic spray apparatus has a nozzle 201 affixed to an arm 202. Liquid flows through a tube or other hollow passage in the arm 202 and then flows through the nozzle 201 from where it is sprayed upon the wafer 204. Thus the arm 202 and nozzle 201 are in fluid communication. The wafer 204 is rotated by wafer spinner equipment 212a,b,c. The liquid is typically cavitated in the nozzle 201 by a piezoelectric crystal located within nozzle 201 and powered by power unit 203. A number of megasonic spray process parameters concern the position of the nozzle 201.

The nozzle 201 may be positioned in a number of different ways. First, the height 205 of the nozzle 201 above the wafer 204 (referred to as “nozzle height”) may be varied; typically by adjusting the height 216 of the arm 202 above the wafer 204. Also, the nozzle 201 is typically designed to rotate. Such a nozzle may be referred to as a rotatable nozzle. In the embodiment of FIG. 2, the nozzle head rotates about the x axis 209, y axis 210 and z axis 211 resulting in three angular positions: θ206, φ207, α208, respectively. Thus nozzle 201 position may be described by four possible process parameters: the nozzle height 205 and three angular positions: θ206, Φ207, α208.

Another megasonic spray parameter concerns the rotational speed of the wafer 204 (also referred to as “wafer speed”) as driven by the wafer spinner equipment 212a,b,c. The wafer speed is typically given in units of wafer rotations per minute (or RPM). As discussed, the faster the wafer rotates, the thinner the boundary layer 213 becomes since the liquid is more aggressively driven to the outer edge of the wafer by the centripetal force associated with the spinning wafer 204. This also corresponds to faster fluid flow of the boundary layer 213 liquid in a radial direction over the wafer 204 surface.

Another megasonic spray parameter concerns the motion of the nozzle 201 with respect to the location of the wafer 204. Most megasonic spray equipment allow for the nozzle 201 to move back and forth 214 along the x axis 209 over the surface of the wafer 204. That is, referring to FIG. 2, the nozzle 201 moves from the wafer center 215 to the wafer edge 216 and then back to the wafer center 215 (i.e., back and forth over the radius of the wafer 204). Such motion (from wafer center 215 and back again) is referred to as a sweep. Thus additional process parameters concern the number of sweeps per complete wafer 204 rinsing as well as the time consumed for each sweep per complete wafer 204 rinsing. The number of sweeps multiplied by the time consumed may be referred to as the total sweep time per complete wafer 204 rinsing. Other sweep patterns are possible as well.

Thus process parameters may be characterized as follows: 1) those that relate to the wafer 204 rotation (wafer speed); 2) those that relate to the nozzle 201 (nozzle height 205 and angular positions θ206, φ207, α208); 3) those that relate to the relative motion of the nozzle 201 with the position of the wafer 204 (number of sweeps, time consumed per sweep) and 4) additional parameters such as: liquid flow rate through the nozzle 201, type of liquid used, and the frequency of the megasonic agitation.

The following is a discussion concerning a series of experiments performed to better understand various process parameters on megasonic related cleaning efficiencies. Observations were made for 1, 2, and 3 sweeps per complete wafer rinsing. Also, further observations were made for the time consumed per sweep at 10, 14, 20 and 28 seconds resulting in a range of total sweep times from 10 seconds (1 sweep×10 seconds per sweep) to 84 seconds (3 sweeps×28 seconds per sweep). A megasonic frequency of 1.5 Mhz was used. The flow rate of liquid through the nozzle 201 ranged from 0.8 liters/min to 2.0 liters/min. The liquid used was DI water having a resistivity of 18 MΩ.

All of these experiments were performed upon an OnTrak™ Series II DSS-200 scrubbing system. Both 150 mm and 200 mm wafers were processed. The wafers were processed in a number of semiconductor processing applications such as: 1) post Shallow Trench Isolation (STI) Chemical Mechanical Polishing (CMP); 2) post Tungsten (W) CMP; 3) post Copper (Cu) CMP; 4) Post Oxide (O2) CMP; 5) Tungsten Etch Back (WEB) and 6) “Silicon (Si) Drilling” associated with the processing of Si devices used within ink-jet printers. In Si Drilling, holes are formed through the thickness of wafer 204 which require thorough cleaning after the drilling is performed. Si Drilling typically produces particles >0.5 μm.

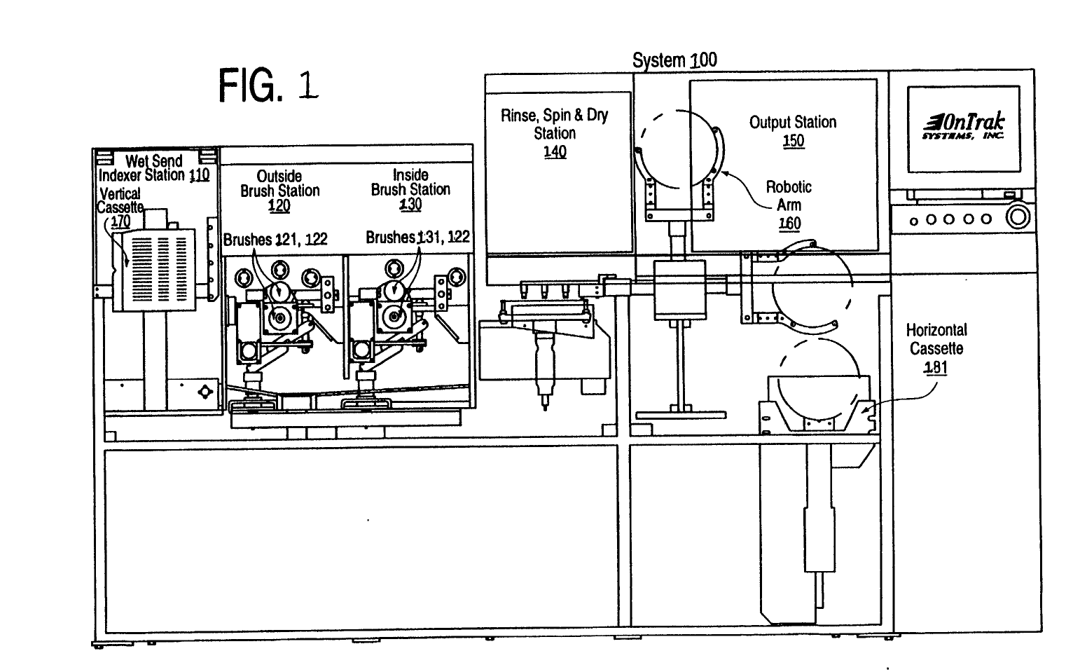

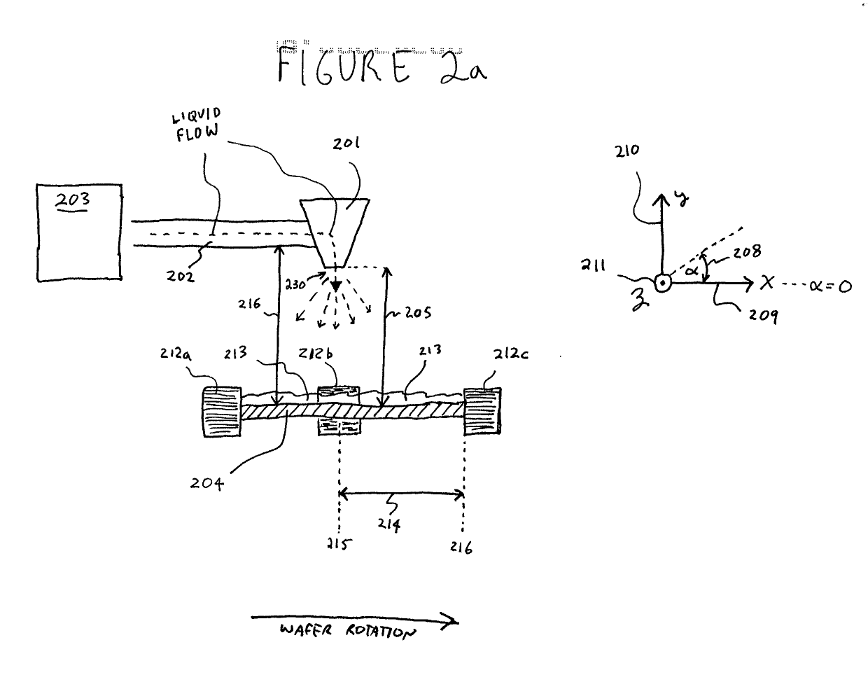

Typically, for all these applications (and referring to FIG. 1), the wafer is brushed in both stations 120 and 130 before being placed in the rinse, spin, dry station 140. In station 140, the megasonic liquid is sprayed on the wafers for a total sweep time before simply spinning until dry. Once the wafers leave station 140 they are added to output station 150. These experiments may further extend to substrates in general as opposed to wafers or silicon wafers, specifically.

### Wafer Speed

Typical industry wafer speeds during megasonic rinsing are within a range of 100-300 RPM. Here, noticeably improved cleaning efficiencies were observed for wafer speeds in a range of 1000-1400 RPM. In one experiment employing a 10 mm nozzle height 205, average cleaning efficiencies obtained at 100-300 RPM speeds where improved by more than a factor of two (from 14.5% to 30% for >0.15 μm particles) simply by increasing the wafer speed to a range of 1000-1400 RPM. For >0.5 μm particles, visual inspection indicated cleaning efficiencies of well over 50% within the 1000-1400 RPM range. Generally, cleaning efficiency is found to improve approximately twiceover (e.g., 20% to 37.5% in another experiment) when wafer speed is increased from 100-300 RPM to 1000-1400 RPM with all other process parameters fixed. Furthermore, improvements less than approximately twiceover were observed for RPM values from 400 to 1000 RPM. Thus, the effects of wafer speeds above 300 RPM on cleaning efficiency have been observed.

Thus cleaning efficiency has been found to improve with increasing wafer speed. At higher wafer speeds, the boundary layer 213 thickness is reduced (for a fixed flow rate from nozzle 201) because the radial flow of liquid across the wafer 204 surface increases. It is believed that cleaning efficiency improves because of this increased radial flow rate or reduced thickness. Conceivably, it is more difficult for loosened particles to re-affix themselves to the wafer 204 surface under higher boundary layer 213 radial flow conditions

### Nozzle Position

It is generally known in the art of megasonic rinsing that nozzle height 205 is recommended at 10 mm-20 mm above the wafer 204 with angular positions θ206, φ207, α208 all set to zero. Wafer cleaning efficiency has been found to be uniform within this range, such that there is little variation in observed cleaning efficiencies achieved with nozzle height 205 of 10 mm-20 mm and where all angular positions θ206, φ207, α208 of the nozzle 201 are zero as shown in FIG. 2. Observed cleaning efficiencies are typically around 50+/−5%.

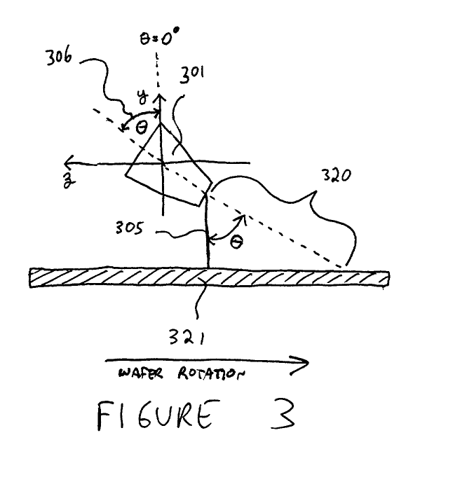

Wafer cleaning efficiency was found to degrade to unacceptable levels for nozzle heights 205 below 10 mm with angular positions θ206, φ207, α208 set to zero. However, referring to FIG. 3, acceptable cleaning efficiencies have been observed for nozzle heights 305 below 10 mm (as well as above 10 mm) having non zero angular position θ306. It is believed that non-zero angular position θ306 improves the cavitation activity. Specifically, referring back to FIGS. 2a and 2b, it is believed that for θ=0° and α=0° (i.e., when the nozzle 201 is positioned to direct liquid flow at a normal incident angle to wafer 204), sonic waves (from megasonic unit 203) which emanate through the nozzle 201 reflect off of the wafer 204 surface and cancel out or reduce the amplitude of sonic waves used for cavitation within nozzle 201. The deconstructive interference results in reduced cleaning efficiencies.

Thus, referring back to FIG. 3, tilting the nozzle 301 (such as non-zero θ306 as shown) eliminates reflected waves from entering the nozzle 301. Noticeable cleaning efficiency improvement is seen for θ306 values greater than 2°. For nozzle heights 305 of 3 mm or more, optimum cleaning efficiency appears to be at 45° with gradual reduction in cleaning efficiency (from the 45° efficiency) starting at 55° and higher.

Referring back to FIGS. 2a and 2b, the aforementioned recommended minimum nozzle height 205 of 10 mm (with θ, α, φ=0°) is used to dissipate reflected wave energy. That is, reflected waves entering the nozzle 201 when the nozzle height 205 is 10 mm or higher have insufficient amplitude to significantly reduce cavitation activity in megasonic unit 203. As such, referring back to FIG. 3, nozzle heights 305 as low as 3 mm have been used with non-zero θ306 angles.

For example, at a nozzle height 305 of 3 mm and θ306 values of 0°, 30° and 45° observed cleaning efficiencies for particles >0.15 μm (in diameter) were 23%, 32% and 38% respectively. Thus, cleaning efficiency improved with increasing θ306.

### Number of Sweeps and Time Consumed Per Sweep

Cleaning efficiencies are stable for total sweep times (i.e., per wafer cleansing run: the number of sweeps×the time consumed per sweep) above 20 seconds. That is, cleaning efficiency is not strongly correlated to total sweep time provided the total sweep time is above 20 seconds. However, for wafer speed values above 400 RPM, improvements in cleaning efficiency (as compared to wafer speeds in the 100-300 RPM range) were observed for total sweep times as low as 10 seconds. Below 10 seconds cleaning efficiencies may drop noticeably, probably due to the lack of exposure to cavitation activity, needed for particle removal, that occurs upon the wafer surface.

### Liquid and Liquid Flow Rate

In one embodiment, DI water having an 18 MΩ resistivity (at a flow rate from 0.8 to 2.0 liters/min) is used. Generally, cleaning efficiency improves with flow rate. In one embodiment, optimal cleaning efficiencies occur with a flow rate around 2.0 liters/min. Similar to increased wafer speed, increased flow rate is believed to produce faster fluid flow over the wafer 204 surface or more cavitation activity over the wafer surface. Flow rates are, for the purposes of this discussion, measured at the nozzle opening 230. Other liquids that may be used include dilute ammonia, SC1 (which is NH₄OH: H₂O₂:H₂O at proportions of 1:4:20 by volume) and surfactants.

### Megasonic Frequency

In one embodiment, the megasonic frequency is fixed at 1.5 MHz. However, as discussed, the typical working megasonic frequency range is 0.4-1.5 MHz.

### Processes

Generally, better cleaning efficiencies may be obtained with processes having: 1) wafer speeds above 1000 RPM; 2) nozzle height higher than 10 mm and nozzle angle θ greater than 2°, 3) total sweep times over 20 seconds and 4) 18 MΩ resistivity DI water flow at 1.5 liters/min. or higher.

What is claimed is:

1. An method, comprising:
a) spraying a liquid agitated with a sonic wave at a megasonic frequency onto a substrate from a nozzle positioned over the substrate;
b) spinning the substrate above 300 RPM simultaneously with the spraying of the liquid; and
c) sweeping the nozzle over the substrate simultaneously with the spraying of the liquid.

2. The method of claim 1 wherein the spinning occurs at 1000 RPM or higher.

3. The method of claim 1 wherein the sweeping occurs for a total sweep time at or above 10 seconds.

4. The method of claim 3 wherein the sweeping of the nozzle occurs according to a total sweep time of 20 seconds.

5. The method of claim 1 wherein the spraying of the liquid occurs with a flow rate between 0.8 and 2.0 liters/min inclusive.

6. The method of claim 1 further comprising flowing the liquid through an arm prior to the spraying.

7. The method of claim 1 further comprising positioning the nozzle at height above the substrate between 10 mm and 20 mm inclusive.

8. The method of claim 1 further comprising positioning the nozzle at an angular position θ greater than 0°.

9. The method of claim 8 further comprising positioning the nozzle at an angular position θ between 45° and 55° inclusive.

10. A method, comprising:
a) brushing a substrate in a brush station;
b) spraying a liquid agitated with a sonic wave at a megasonic frequency onto the substrate from a nozzle positioned over the substrate;
c) spinning the substrate above 300 RPM simultaneously with the spraying of the liquid; and
d) sweeping the nozzle over the substrate simultaneously with the spraying of the liquid.

11. The method of claim 10 further comprising performing chemical mechanical polishing (CMP) to the substrate prior to the brushing.

12. The method of claim 11 wherein the CMP is performed upon a shallow trench isolation region.

13. The method of claim 11 wherein the CMP is performed upon Tungsten.

14. The method of claim 11 wherein the CMP is performed upon Copper.

15. The method of claim 11 wherein the CMP is performed upon an Oxide.

16. The method of claim 10 further comprising performing a Tungsten etch back process to the substrate prior to the brushing.

17. The method of claim 10 further comprising performing Si drilling to the substrate prior to the brushing.

18. An apparatus, comprising: p1 a) an arm;
b) a nozzle in fluid communication with the arm having an angular position θ greater than 0°; and
c) a substrate spinner positioned below the nozzle.

19. The apparatus of claim 18 wherein the arm and nozzle are located within a rinse, spin, dry station.

20. The apparatus of claim 19 further comprising a brush station coupled to a rinse, spin, dry station.

21. The apparatus of claim 18 wherein the angular position θ is 45°.

22. The apparatus of claim 18 wherein the substrate spinner is spinning a substrate at or above 400 RPM.

23. An apparatus, comprising:
a) means for spraying a liquid agitated with a sonic wave at a megasonic frequency onto a substrate from a nozzle positioned over the substrate;
b) means for spinning the substrate above 300 RPM simultaneously with the spraying of the liquid; and
c) means for sweeping the nozzle over the substrate simultaneously with the spraying of the liquid.

24. The apparatus of claim 1 further comprising means for positioning the nozzle at height above the substrate between 10 mm and 20 mm inclusive.

25. The apparatus of claim 1 further comprising means for positioning the nozzle at an angular position θ greater than 0°.
